(19) United States
(12) Patent Application Publication
(10) Pub. No.: US 2012/0285840 A1
(43) Pub. Date: Nov. 15, 2012

(54) CASH PLATE

(76) Inventor: Xiancai PAN, Richmond (CA)

(21) Appl. No.: 13/464,632

(22) Filed: May 4, 2012

(30) Foreign Application Priority Data
May 10, 2011 (CN) 201120145277.5

(51) Int. Cl. G09F 23/02; G09F 23/04; B65D 85/00

(52) U.S. Cl. 206/81

(57) ABSTRACT

One aspect of the invention provides a cash plate comprising: a cash tray; a display tray attached to the cash tray and located next to the cash tray; one or more advertisement placement means located under the cash tray for placing and displaying an advertisement; and a base under the cash tray, the display tray and the advertisement placement means. One aspect of the invention provides a method of advertising comprising the steps of: placing an advertisement on a cash plate; and presenting cash on the cash plate to a customer at a point of sale.

### RELATED APPLICATION

This application claims priority from Chinese Utility Model Application No. 201120145277.5 filed 10 May 2011, which is hereby incorporated by reference.

### TECHNICAL FIELD

The present invention relates to cash plates, and in particular, cash plates with advertising and/or product display functions.

### BACKGROUND

Conventional cash plates generally have only one function, that is, the cash plate merely functions as keeping or presenting changes for customers with no other affiliated functions.

### BRIEF DESCRIPTION OF DRAWINGS

In drawings which show non-limiting embodiments of the invention:

FIG. 1 is a schematic top plan view of a cash plate according to an example embodiment.

FIG. 2 is a schematic front side view of the cash plate of FIG. 1.

FIG. 3 is a schematic left side view of the cash plate of FIG. 1.

FIG. 4 is a schematic top plan view of a cash plate according to another example embodiment.

FIG. 5 is a schematic front side view of the cash plate of FIG. 4.

FIG. 6 is a schematic top plan view of a cash plate according to another example embodiment.

FIG. 7 is a perspective view of a cash plate according to another example embodiment.

FIG. 8 is a perspective view of a cash plate according to another example embodiment.

FIG. 9 is a perspective view of a cash plate according to another example embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

One of the objects of this invention is to provide a cash plate with advertising and/or product display functions, so that it can function to advertise or promote a product or service when the cash plate is used to present or give changes (e.g., coins, banknotes, or combinations thereof) or other items (e.g., credit cards, receipts, tickets, or promotional items) to customers.

The technical proposal adopted in this invention is that the cash plate according to this invention contains a cash tray, a display tray located next to the cash tray, and advertisement placement means located under the cash tray and/or display tray. The cash plate may also comprise a base located under the cash tray, the display tray and the advertisement placement means.

Advantages of the cash plate according to this invention include: 1. because the display tray is designed next to the cash tray, customers can notice the product and/or ads displayed when customers are picking up the changes from the cash tray, thus realizing the function of advertising and promoting sales; 2. because of lights placed in the base, customers can clearly see the changes on the cash tray as well as the advertisement and/or product displayed even in places with poor lighting; furthermore, the lights may be switched on in response to external signals, e.g., the lights may automatically switch on when a customer gets close to the cash plate (e.g., within 50 cm, 40 cm, 30 cm, 20 cm, or 10 cm of the cash plate) or touches the cash plate, so it will attract the customer's attention, and have a better advertising effect.

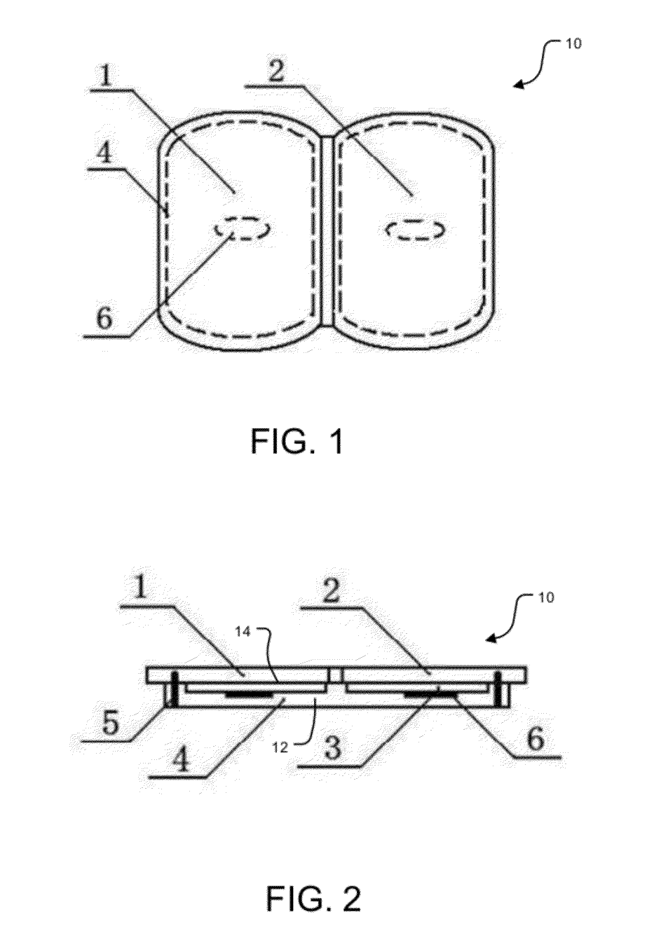

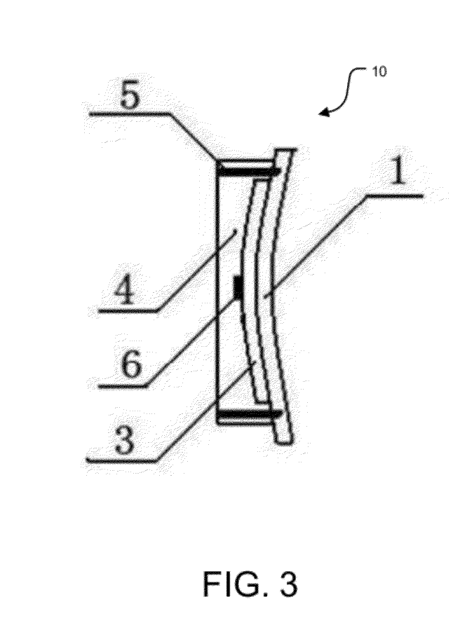

FIGS. 1 to 3 are schematic drawings of a cash plate 10 according to an example embodiment of the invention. Cash plate 10 comprises a cash tray 1 and a display tray 2 next to the cash tray 1. Cash plate 10 also comprises one or more advertisement placement means 3 under cash tray 1 and/or display tray 2. Advertisement placement means 3 may be in the form of a slot, an aperture, a hole, a cavity, or a space. An advertisement (e.g., a printed advertisement sheet) may be placed in advertisement placement means. Cash plate 10 may also comprise a base 4 which is located under cash tray 1, display tray 2 and advertisement placement means 3. Base 4 defines an interior space 12 which is between cash tray 1, display tray 2 and the bottom portion of base 4. Lights 6 may be provided in base 4. In FIG. 2, lights 6 are shown located under advertisement placement means. Lights 6 provide lighting or illumination to the advertisement placed in advertisement placement means 3, and/or a product placed in display tray 2, and/or cash placed in cash tray 1.

As illustrated in FIG. 2, base 4, cash tray 1 and display tray 2 are connected by connectors 5.

In operation, cash plate 10 may be used independently. Alternatively, cash plate 10 may be used in conjunction with a cash handling machine (e.g., a cash register). Cash may be placed in cash tray 1 of cash plate 10 manually (e.g., by a cashier). Alternatively, cash may be placed in cash tray 1 by a cash handling machine. Cash plate 10 is presented to a customer and the customer picks up the cash from cash tray 1. When the customer picks up the cash with his/her hand, the customer sees the advertisement and/or product placed on cash plate 10, thus realizing the advertising and/or product display functions of cash plate 10.

In some embodiments, cash plate 10 is movable, i.e., can be carried from one location to another location. In some embodiments, cash plate 10 may be attached to a fixture or an apparatus. For example, cash plate may be attached to a counter.

Cash tray 1 comprises a surface 14 upon which cash is placed. Surface 14 may be transparent so that a customer can see the advertisement placed under surface 14. Surface 14 may be made of glass or plastic or some other suitable material. Surface 14 may be flat or curved. In some embodiments, advertisement may be placed on top of surface 14 instead of under surface 14.

In some embodiments, surface 14 may be removable from cash plate 10. For example, surface 14 may be a glass sheet or a plastic sheet. This allows a person to remove surface 14 from cash plate 10 and easily replace the advertisement in advertisement placement means 3.

In some embodiments, instead of placing an advertisement in cash plate 10, an item (e.g., a product, a promotional item, or a sample) is placed in interior space 12 of cash plate 10. A customer can view the item through surface 14 when he/she picks up the cash from surface 14. This may be advantageous in certain situations. For examples, in jurisdictions where print advertisements for tobacco products are prohibited, a merchant may place the actual tobacco product in interior space 12 of cash plate 10 to draw a customer's attention. Of course, the items that may be placed in interior space 12 are not limited to tobacco products. For example, chewing gums, stickers, toys, key chains, snacks, gift cards, and many other items may also be placed in interior space 12.

In the illustrated embodiment, cash plate 10 comprises a display tray 2. However, in some embodiments, it is not necessary to provide a display tray 2. Display tray 2 is located next to cash tray 1. In some embodiments, display tray 2 is fixedly attached to cash tray 1. In some embodiments, display tray 2 is removably attached to cash tray 1. A product may be placed in display tray 2 to draw a customer's attention. The product placed in display tray 2 may be the same product advertised in the advertisement placed in advertisement placement means 3. A customer sees the product when he/she picks up the cash from cash plate 10. The customer may request to purchase the displayed product.

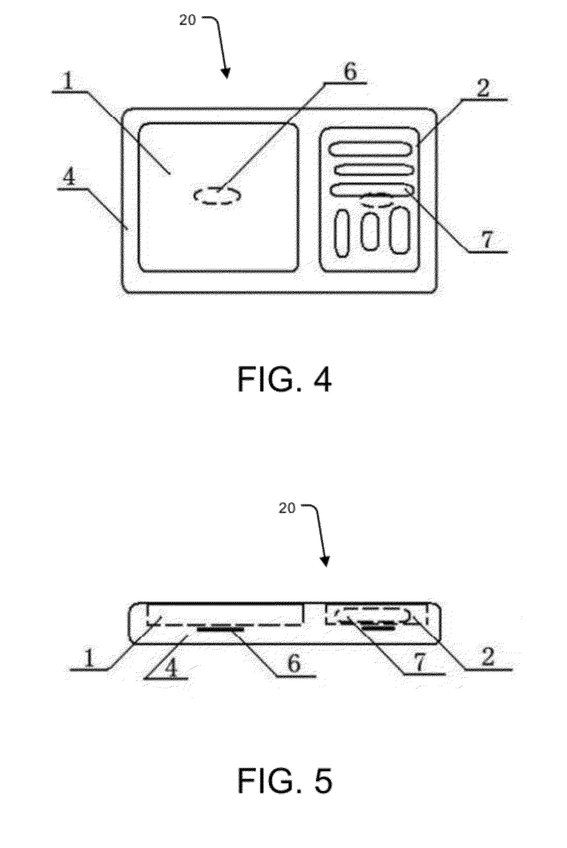

FIGS. 4 and 5 are schematic drawings of a cash plate 20 according to another embodiment. Cash plate 20 comprises a cash tray 1 and a display tray 2 next to the cash tray 1. Cash plate 20 may also comprises one or more advertisement placement means (not specifically indicated in FIGS. 4 and 5) under cash tray 1 and/or display tray 2. Cash plate 20 also comprises a base 4 which is located under cash tray 1 and display tray 2. Lights 6 are provided under cash tray 1 and/or display tray 2 for illumination purposes. At least one product 7 is shown placed in display tray 2.

In FIGS. 4 and 5, the components of cash plate 20 (i.e., base 4, cash tray 1, display tray 2) are made as an integral construction.

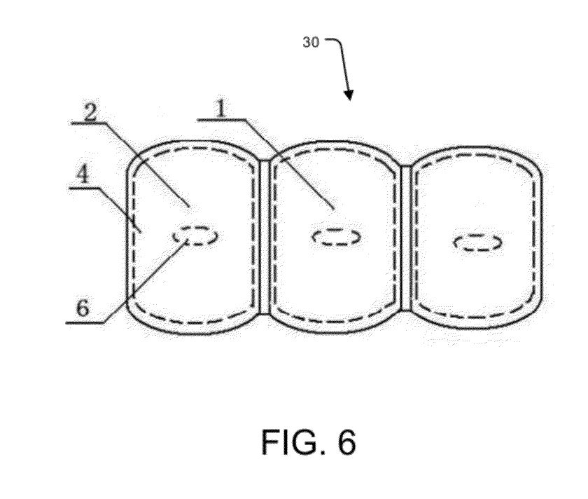

FIG. 6 is a schematic drawing of a cash plate 30 according to another embodiment. Cash plate 30 comprises a cash tray 1 and one or more display tray 2 next to the cash tray 1. Cash plate 30 may also comprise one or more advertisement placement means (not specifically indicated) under cash tray 1 and/or display tray 2. Cash plate 30 also comprises a base 4 which is located under cash tray 1 and display tray 2. Lights 6 are provided under cash tray 1 and/or display tray 2 for illumination purposes.

The phrase “next to the cash tray” herein should be interpreted to include to the left, right, upper or lower side of the cash tray. One or more display trays may be attached to the left, right, upper or lower side of the cash tray either individually or in any combination (e.g., left side and right side, or left side and lower side, etc.)

The cash tray and/or the display tray may be made of transparent materials.

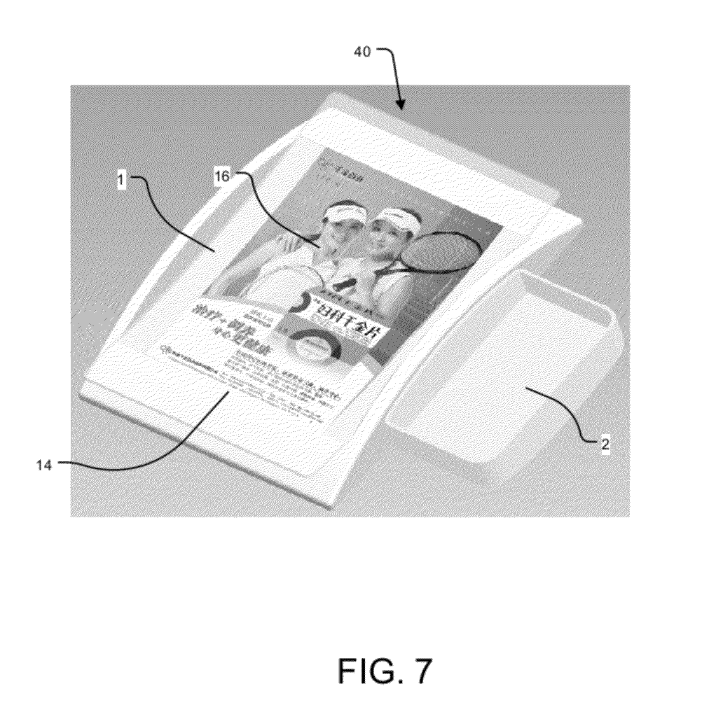

FIG. 7 shows an example cash plate 40 which contains a cash tray 1 and a display tray 2. The cash tray 1 comprises a removable transparent surface 14. A printed advertisement 16 is placed under surface 14. Cash may be placed on surface 14. When a customer picks up the cash from surface 16, he/she will see advertisement 16.

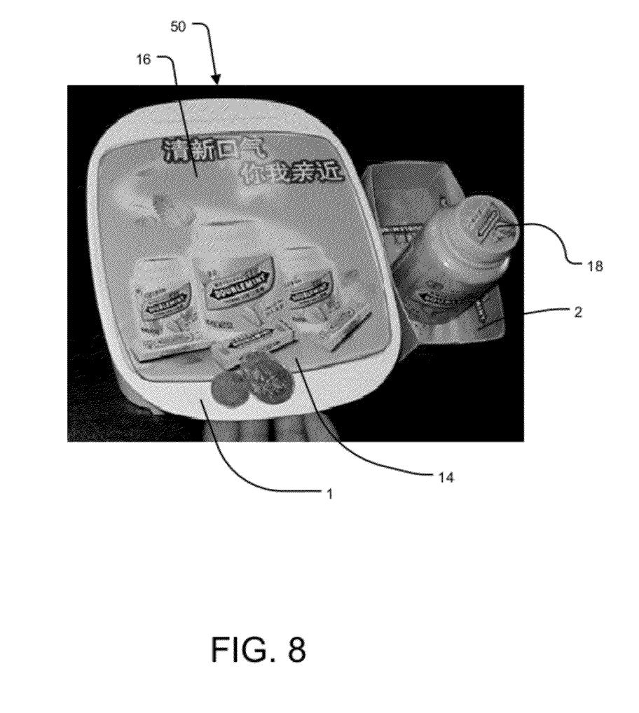

FIG. 8 shows an example cash plate 50 which contains a cash tray 1 and a display tray 2. The cash tray 1 comprises a transparent surface 14. A printed advertisement 16 is placed under surface 14. A product 18 (which is the same type of product as advertised on advertisement 16) is placed in display tray 2. Cash may be placed on surface 14. When a customer picks up the cash from surface 14, he/she will see advertisement 16 and product 18. If the customer likes product 18, the customer may request to purchase product 18.

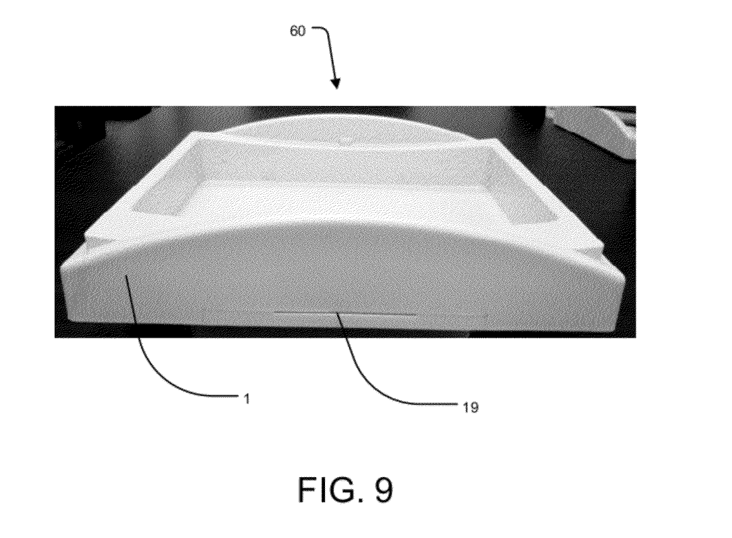

FIG. 9 shows an example cash plate 60 which comprises a cash tray 1. To illustrate a slot 19 on the side of cash tray 1, a display tray is not specifically shown in FIG. 9. A display tray may be removably attached to cash tray 1. For example, a display tray may have a connecting portion (not shown) that fits into slot 19 of cash tray 1. It is not mandatory for slot 19 to be on the side of cash tray 1. Slot 19 may be provided at any suitable location of cash tray 1. In some embodiments, a slot may be provided on a display tray instead of cash tray 1. Other attaching means may be used as an alternative to the slot mechanism. For example, a display tray may be removably attached to cash tray 1 by an adhesive (e.g., an adhesive tape, or glue), or fasteners (e.g., screws, or bolts and nuts, etc.), or hoop and loop means.

This allows a user to mix and match a variety of cash trays with a variety of display trays. The cash trays and the display trays may be provided in different sizes, patterns, and/or colors for such combinatorial mix-and-match. For example, the cash tray and/or display tray may be provided in a color that matches or corresponds to the color of the displayed product or the advertisement. The cash tray or display tray may be replaced with a different one when the user needs to advertise a different product or service.

The cash plate described herein provides an effective advertising method. The method is direct, targeted, and very visual. It provides effective advertising in many point-of-sale situations, e.g., convenience stores, grocery stores, tobacco stores, restaurants, hotels, dry cleaners, hair salons, ice cream stores, etc., where cash transactions are common. The method comprises the steps of: placing an advertisement on a cash plate; presenting cash to a customer at a point of sale on the cash plate. When a customer picks up the cash from the cash plate, he/she will have no choice but to focus his/her attention to the advertisement on the cash plate. The method may also comprise the step of: placing a product on the cash plate, wherein the product corresponds to a product advertised on the advertisement placed on the cash plate.

The cash plate described herein is not limited to present cash to customers. The cash plate of the present invention can be used to present and/or deliver other items (e.g., credit cards, receipts, tickets, or promotional items) to customers while providing the advertising and/or product display functions at the same time.

The above detailed description of example embodiments of the invention are not intended to be exhaustive or to limit the invention to the precise form disclosed above. While specific embodiments of the invention are described for illustrative purposes, various modifications are possible, as those skilled in the relevant art would recognize.

Various elements of the invention may be used alone, in combination, or in a variety of arrangements not specifically discussed in the embodiments described in the foregoing. For example, elements described in one embodiment may be combined with elements described in other embodiments.

The scope of the claims should not be limited by the embodiments set forth in the examples, but should be given the broadest interpretation consistent with the description as a whole.

What is claimed is:

1. A cash plate comprising:
a cash tray;
a display tray attached to the cash tray and located next to the cash tray;
one or more advertisement placement means located under the cash tray for placing and displaying an advertisement; and
a base under the cash tray, the display tray and the advertisement placement means.

2. The cash plate according to claim 1, comprising a light source for illuminating the advertisement placed in the advertisement placement means.

3. The cash plate according to claim 1, wherein the advertisement is a print advertisement.

4. The cash plate according to claim 1, wherein the base defines an interior space.

5. The cash plate according to claim 4, wherein a product is placed in the interior space defined by the base.

6. The cash plate according to claim 1, wherein the cash tray comprises a transparent surface.

7. The cash plate according to claim 6, wherein the transparent surface is removable.

8. The cash plate according to claim 7, wherein the transparent surface is a glass or plastic sheet.

9. The cash plate according to claim 1, wherein the cash tray is made of a transparent material.

10. The cash plate according to claim 1, wherein the display tray is made of a transparent material.

11. The cash plate according to claim 1, wherein the display tray is fixedly attached to the cash tray.

12. The cash plate according to claim 1, wherein the display tray is removably attached to the cash tray.

13. The cash plate according to claim 1, wherein the advertisement placement means allows the advertisement to be replaced.

14. The cash plate according to claim 2, wherein the light source switches on automatically when a customer is in proximity of the cash plate.

15. The cash plate according to claim 2, wherein the light source switches on automatically when a customer's hand touches the cash plate.

16. A method of advertising comprising the steps of:
placing an advertisement on a cash plate; and
presenting cash on the cash plate to a customer at a point of sale.

17. The method according to claim 16, comprising:
placing a product on the cash plate.

18. The method of claim 15, wherein the product placed on the cash plate corresponds to a product advertised on the advertisement placed on the cash plate.

19. The method of claim 16, wherein the advertisement is illuminated by a light source in the cash plate.

20. The method of claim 19, wherein the light source is automatically switched on when a customer approaches or touches the cash plate.
